(19) United States
(12) Patent Application Publication
(10) Pub. No.: US 2006/0254627 A1
(43) Pub. Date: Nov. 16, 2006

(54) Dishwasher with utensil basket

(75) Inventor: Sung Bae Lim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/376,558

(22) Filed: Mar. 16, 2006

(30) Foreign Application Priority Data
Mar. 17, 2005 (KR) 10-2005-0022435

(51) Int. Cl. B08B 3/00

(52) U.S. Cl. 134/134

(57) ABSTRACT

A dishwasher with a utensil basket is provided. The dishwasher includes a dish rack receiving kitchen utensils and a utensil basket detachably coupled to one side of the dish rack for receiving silverware. The utensil basket includes a basket base forming a lower portion of the utensil basket, a body frame detachably coupled to one side of the basket base, and a fixing part formed on the basket base or the body frame for detachably coupling the utensil basket to the dish rack.

### BACKGROUND OF THE INVENTION

1. Field of the Invention

The present invention relates to a dishwasher, and more particularly, to a dishwasher having a utensil basket for various silverware products such as spoons, forks, knifes, and dippers.

2. Description of the Related Art

A dishwasher is a device that removes foreign substances such as remaining food and dirt from kitchen utensils by injecting washing liquid at a high pressure through an injection nozzle.

In detail, a dishwasher includes a tub forming a washing chamber and a sump installed under the tub for storing washing liquid. The washing liquid is pushed to an injection nozzle by a washing pump installed in the sump, and then injected at a high pressure through an injection hole formed in an end of the injection nozzle.

The injected washing liquid removes dirt such as remaining food from dishes by colliding with the dishes. The removed dirt drops to a bottom of the tub.

The dishwasher further includes at least one dish rack extendable from the tub for receiving kitchen utensils. Generally, two dish racks are detachably installed in the tub at upper and lower positions.

The dish rack is formed by bending and welding frames for receiving kitchen utensils.

Bars of the frames are spaced a predetermined distance from each other, such that kitchen utensils having a relatively large size such as bowls and trays does not sink down but washing liquid injected to the kitchen utensils drain well.

However, silverware products such as spoons, forks, and knives are not easily put on the dish rack because of the space between the bars of the frame.

Further, if the silverware products fall to a bottom surface of the tub through the space between the bars of the frame, washing liquid is not smoothly circulated since the fallen silverware products block a filter hole formed in the bottom surface of the tub.

### SUMMARY OF THE INVENTION

Accordingly, the present invention is directed to a dishwasher with a utensil basket that substantially obviates one or more problems due to limitations and disadvantages of the related art.

An object of the present invention is to provide a dishwasher having a utensil basket for separately receiving small and relatively long silverware such as spoons, forks, and knives.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dishwasher including: a dish rack receiving kitchen utensils; and a utensil basket detachably coupled to one side of the dish rack for receiving silverware, wherein the utensil basket includes a basket base forming a lower portion of the utensil basket, a body frame detachably coupled to one side of the basket base, and a fixing part formed on the basket base or the body frame for detachably coupling the utensil basket to the dish rack.

Therefore, according to the dishwasher of the present invention, small and relatively long utensils and silverware products can be easily accommodated on the utensil basket. Further, since the utensil basket is detachably coupled to the dish rack of the dishwasher, the utensil basket can be removed from the dishwasher when the utensil basket is not required.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a dish rack on which a utensil basket can be mounted according to an embodiment of the present invention;

FIG. 2 is a front perspective view of a utensil basket for receiving kitchen utensils such as spoons according to an embodiment of the present invention;

FIG. 3 is a perspective view of a utensil holder according to another embodiment of the present invention;

FIG. 4 is a rear perspective view of the utensil basket of FIG. 2;

FIG. 5 is a rear perspective view of the utensil basket when the utensil basket is coupled to an accommodation frame;

FIG. 6 is an assembled perspective view of the dish rack and the utensil basket; and

FIG. 7 is a perspective view of a dishwasher provided with a dish rack according to an embodiment of the present invention.

### DETAILED DESCRIPTION OF THE INVENTION

Reference will now be made in detail to the preferred embodiments of the present invention, examples of which are illustrated in the accompanying drawings.

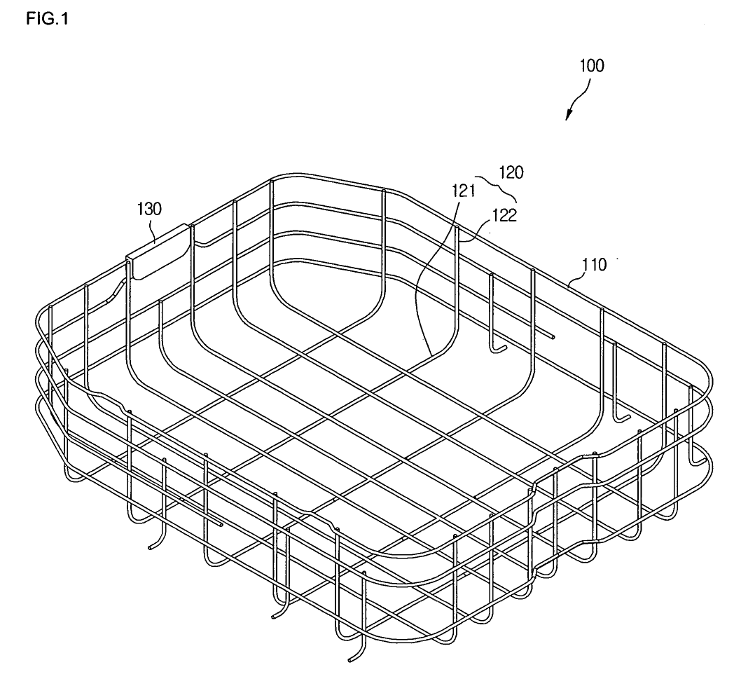

FIG. 1 is a perspective view of a dish rack 100 on which a utensil basket can be mounted according to an embodiment of the present invention.

Referring to FIG. 1, the dish rack 100 includes an outer frame 110 forming the exterior of the dish rack 100, and an accommodation frame 120 coupled to the outer frame 110 for forming a bottom surface of the dish rack 100.

The accommodation frame 120 is bent into a U-shape. The accommodation frame 120 is a supporting structure for tableware products to be put on the dish rack 100.

In detail, the accommodation frame 120 includes bent portions 122 bent at a predetermined angle and coupled to the outer frame 110, and bottom portions 121 forming the bottom surface of the dish rack 100.

A rack grip 130 can be formed on a side of the outer frame. A user can push and pull the dish rack 100 using the rack grip 130.

The above-described structure of the dish rack 100 allows a user to place tableware products on the dish rack 100 and push the dish rack 100 into a tub of a dishwasher. A utensil basket may be mounted on an inner side of the outer frame 110 according to the present invention.

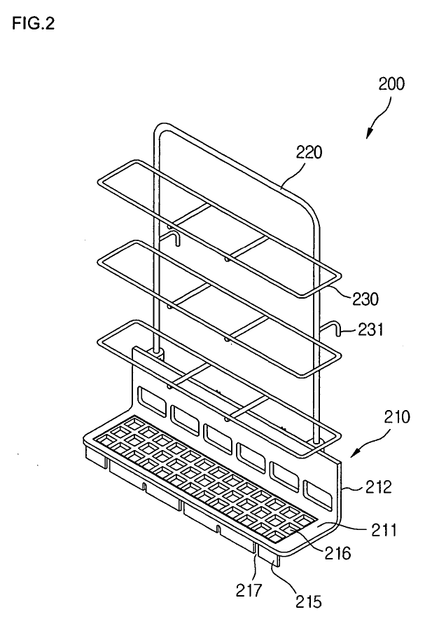

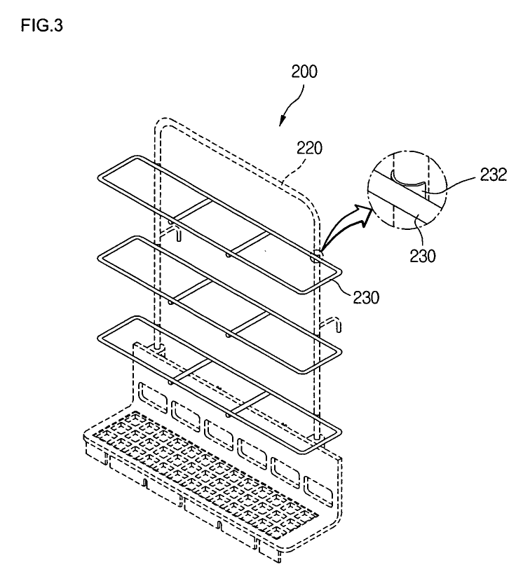

FIG. 2 is a front perspective view of a utensil basket 200 for receiving silverware such as spoons, forks, and knives according to an embodiment of the present invention, and FIG. 3 is a perspective view of a utensil holder according to another embodiment of the present invention.

Referring to FIG. 2, the utensil basket 200 includes a basket base 210, a body frame 220 detachably inserted into the basket base 210, and one or more utensil holders 230 coupled to the body frame 220 for receiving silverware such as dippers and knives.

The utensil holders 230 may be vertically arranged at a predetermined distance from each other.

In detail, the basket base 210 may have an L-shape and be formed of plastic by injection molding. The basket base 210 includes a base bottom portion 211 and a base bent portion 212 extending at a predetermined angle from the base bottom portion 211.

The basket base 210 further includes a number of holes 216 in the base bottom portion 211. Thus, washing liquid can flow down through the holes 216 rapidly.

The base bottom portion 211 includes a rib 215 extending downward by a predetermined length, and accommodation frame inserting holes 217 formed in the rib 215 and having a predetermined depth.

The basket base 210 can be coupled to the dish rack 100 by inserting the bottom portions 121 of the accommodation frame 120 into the accommodation frame inserting holes 217.

Both ends of the body frame 220 are inserted into a rear side of the base bent portion 212 of the basket base 210. In detail, the body frame 220 is bent into a reversed U-shape. The body frame 220 may be formed of the same material as the frames 110 and 120 of the dish rack 100. However, the body frame 220 can be formed of different materials. For example, the body frame 220 can be formed of plastic by injection molding.

The utensil holders 230 are coupled to a front portion of the body frame 220 to support silverware such as spoons, forks, and knives to be accommodated in the utensil basket 200. The utensil holders 230 have a rectangular hoop shape and vertically arranged at a predetermined distance from each other.

The utensil holders 230 are used as a supporting structure for silverware such as spoons, forks, and knives to be placed in the utensil basket 200. The utensil holders 230 are long in a horizontal direction such that long silverware such as knives and dippers can be laid down on the utensil holders 230. Each of the utensil holders 230 are divided into a plurality of sections by bars.

The utensil holders 230 may be detachably coupled to the body frame 220 or fixedly coupled to the body frame 220 by welding.

Referring to FIG. 3, according to another embodiment of the present invention, a utensil holder 230 includes utensil holder fixing parts 232 on one side. The utensil holder 230 can be detachably coupled to the body frame 220 using the utensil holder fixing parts 232. For this, the utensil holder fixing parts 232 are curved with a curvature and size corresponding to those of the body frame 220.

Since the utensil holder 230 can be detachably coupled to the body frame 220 by the utensil holder fixing parts 232, the coupling position of the utensil holder 230 to the body frame 220 can be adjusted.

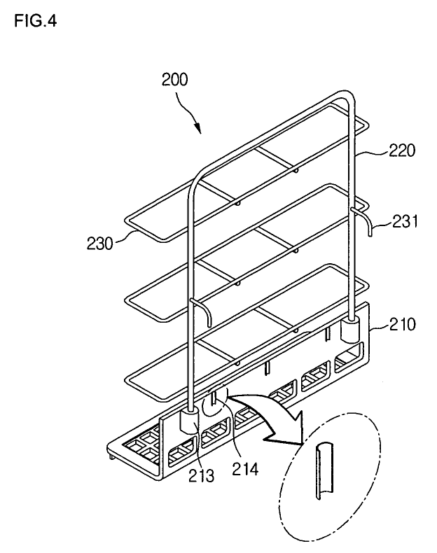

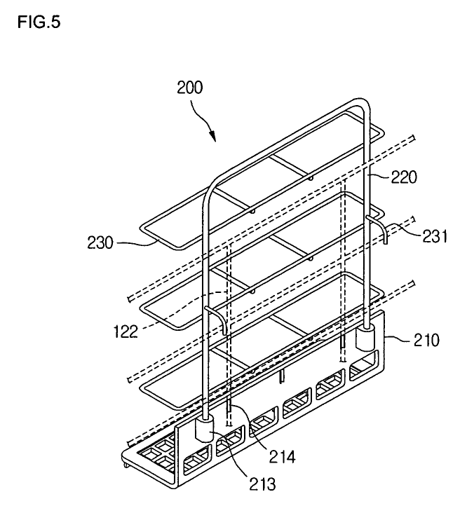

FIG. 4 is a rear perspective view of the utensil basket 200, and FIG. 5 is a rear perspective view of the utensil basket 200 coupled to the accommodation frame 120.

Referring to FIGS. 4 and 5, the basket base 210 includes body frame supports 213 on a rear surface for receiving ends of the body frame 220.

The body frame supports 213 include grooves corresponding to the body frame 220 for receiving the ends of the body frame 220. That is, the body frame 220 is detachably coupled to the rear side of the basket base 210.

The basket base 210 further includes one or more base fixing parts 214 on its rear surface at predetermined positions beside the body frame supports 213 for fixing the basket base 210 to the bent portion 122 of the accommodation frame 120 of the dish rack 100.

To detachably fix the base fixing parts 214 to the bent portions 122 of the accommodation frame 120, the base fixing parts 214 may be protruded from the rear surface of the basket base 210 and curved with a predetermined curvature.

To detachably fix the body frame 220 to the outer frame 110 of the dish rack 100, hooks 231 are formed on a rear surface of the body frame 210.

Therefore, the utensil basket 200 can be securely coupled to the dish rack 100 by the coupling parts such as the hooks 231 and the base fixing parts 214.

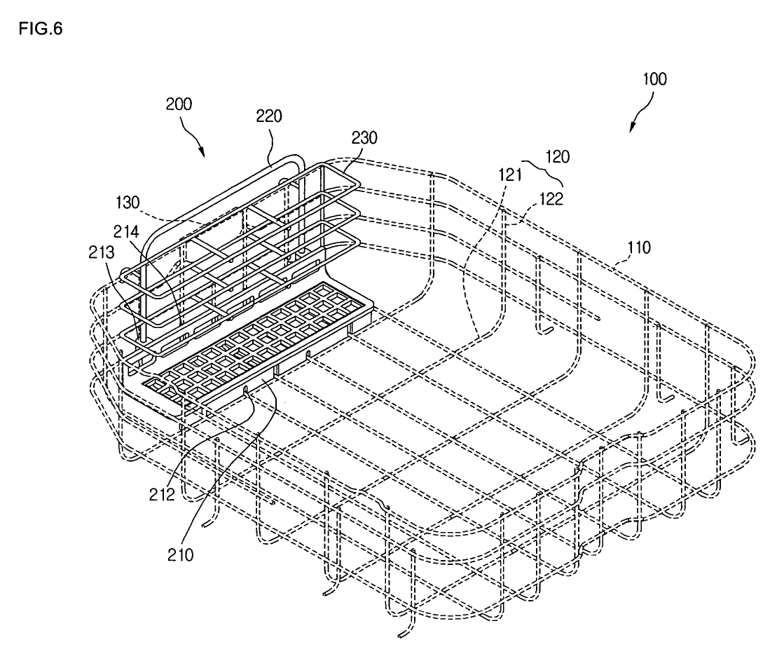

FIG. 6 is an assembled perspective view of the dish rack 100 and the utensil basket 200.

Referring to FIG. 6, the utensil basket 200 is detachably mounted on one side of the dish rack 100.

In detail, for mounting the utensil basket 200 on the dish rack 100, the utensil basket 200 is put against one side of the dish rack 100 to insert the bent portions of the accommodation frame 120 into the base fixing parts 214.

Then, the hooks 231 formed on the rear surface of the body frame 220 is placed on the outer frame 110 of the dish rack 100, and the bottom portions 121 of the accommodation frame 120 are inserted into the accommodation frame inserting holes 217 of the utensil basket 200.

On the contrary, for detaching the utensil basket 200 from the dish rack 100, the utensil basket 200 is reversely lift to release the bottom portions 121 of the accommodation frame 120 from the accommodation frame inserting holes 217, and to release the outer frame 110 from the hooks 231.

Then, the utensil basket 200 is pulled to release the bent portions 122 of the accommodation frame 120 from the base fixing parts 214.

The above-described structure of the utensil basket 200 allows a user to place long silverware such as spoons and chopsticks in the utensil basket 200. The user can put long silverware in the utensil basket 200 in a stand-up position by inserting the long silverware into the utensil holders 230. In this case, one ends of the long silverware products are placed on the basket base 210.

Other silverware such as knives and dippers can be put in the utensil basket 200 in a stand-up position like the spoons and chopsticks, or they can be laid down on the utensil holder 230.

The holes 216, which are formed in the bottom surface of the basket base 210 to drain washing liquid, may have a smaller diameter than that of chopsticks to prevent chopsticks and spoons from falling therethrough.

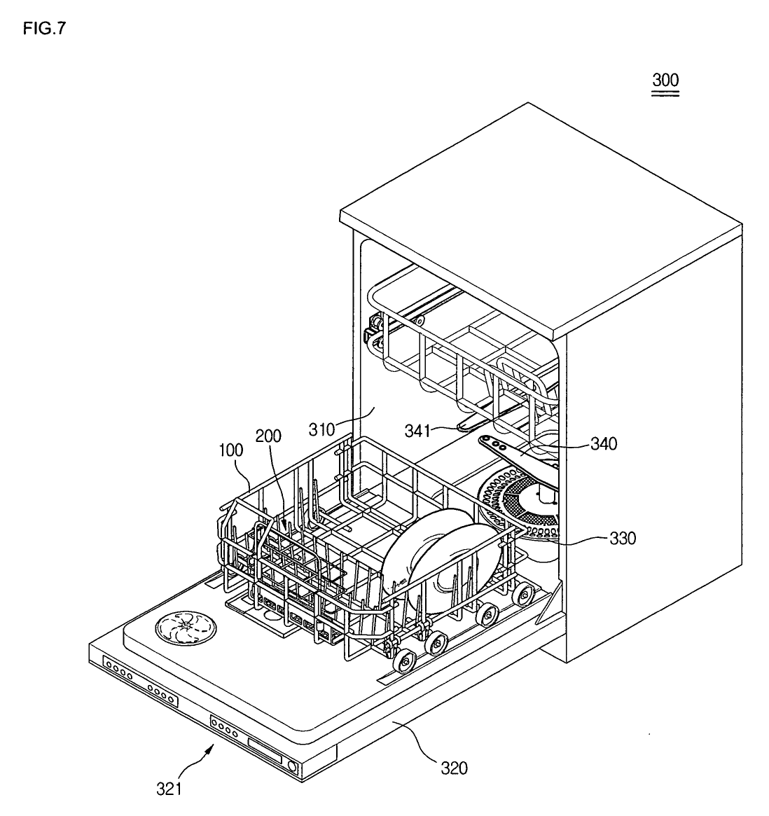

FIG. 7 is a perspective view of a dishwasher provided with a dish rack according to an embodiment of the present invention.

Referring to FIG. 7, a dishwasher 300 according to an embodiment of the present invention includes a washing chamber, a tub 310 forming the exterior of the dishwasher 300, a door 320 installed on the tub 310 and rotatable forwardly, a dish rack 100 extendable from the tub 310, and a sump 330 formed on a bottom portion of the tub 310 for storing washing liquid.

The dishwasher 300 further includes an upper nozzle 341 and a lower nozzle 340 that are formed with injection holes to inject washing liquid pumped from the sump 330.

In detail, the dish rack 100 is extendable from the washing chamber formed by the tub 310. Various silverware products can be put on the dish rack 100 and a utensil basket 200 detachably mounted on one side of the dish rack 100.

Washing liquid stored in the sump 330 is pumped by a washing pump and injected to the kitchen utensils such as dishes and spoons placed on the dish rack 100 and the utensil basket 200 through the upper nozzle 341 and the lower nozzle 340.

The injected washing liquid washes the kitchen utensils and falls to a bottom surface of the tub 310. Then, the washing liquid flows back into the sump 330 through holes formed in a top portion of the sump 330.

The dishwasher 300 may include one or more dish racks, each of the dish racks may be provided with a utensil basket or utensil baskets.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising:
a dish rack receiving kitchen utensils; and
a utensil basket detachably coupled to one side of the dish rack for receiving silverware,
wherein the utensil basket includes a basket base forming a lower portion of the utensil basket, a body frame detachably coupled to one side of the basket base, and a fixing part formed on the basket base or the body frame for detachably coupling the utensil basket to the dish rack.

2. The dishwasher according to claim 1, wherein the utensil basket further includes a hook formed on a rear surface of the body frame for hanging on the dish rack.

3. The dishwasher according to claim 1, wherein the dish rack includes a plurality of frames, and the basket base includes a base fixing part on a rear surface for coupling with the frame.

4. The dishwasher according to claim 1, wherein the basket base includes a frame support on one side for coupling with the body frame.

5. The dishwasher according to claim 1, wherein the basket base includes:
a base bottom portion formed on a lower side and having a predetermined hole; and
a base bent portion extending from the base bottom portion at a predetermined angle.

6. The dishwasher according to claim 5, wherein the base bottom portion includes a rib extending downward by a predetermined length and having an inserting hole for coupling with a frame of the dish rack.

7. The dishwasher according to claim 1, wherein the utensil basket further includes a utensil holder detachably coupled to the body frame, the utensil holder having a hoop shape for supporting the silverware.

8. The dishwasher according to claim 7, wherein the utensil basket further includes one or more utensil holders, and all the utensil holders are vertically arranged at a predetermined distance from each other.

9. A dishwasher comprising:
a dish rack including an outer frame forming an exterior of the dish rack and an accommodation frame coupled to the outer frame for forming a bottom portion of the dish rack; and
a utensil basket detachably coupled to the outer frame or the accommodation frame for receiving silverware,
wherein the utensil basket includes a basket base having an accommodation frame inserting hole for coupling with the accommodation frame, and a body frame detachably coupled to a rear surface of the basket base.

10. The dishwasher according to claim 9, wherein the basket base includes a base bottom portion forming a lower portion of the basket base and a base bent portion extending from the base bottom portion at a predetermined angle, and
the accommodation frame inserting hole is formed in a lower surface of the base bottom portion.

11. The dishwasher according to claim 10, wherein the base bottom portion includes a rib extending from a lower portion of the base bottom portion by a predetermined length, and the accommodation frame inserting hole is formed in the rib to a predetermined depth.

12. The dishwasher according to claim 9, wherein the utensil basket further includes a utensil holder detachably coupled to the body frame, the utensil holder having a hoop shape for supporting the silverware.

13. The dishwasher according to claim 12, wherein the utensil basket further includes one or more utensil holders, and all the utensil holders are vertically arranged at a predetermined distance from each other.

14. A dishwasher comprising:
a dish rack including an outer frame forming an exterior of the dish rack and an accommodation frame coupled to the outer frame for forming a bottom portion of the dish rack; and
a utensil basket detachably coupled to the outer frame or the accommodation frame for receiving silverware,
wherein the utensil basket includes a basket base forming a lower portion of the utensil basket and a body frame having a hook for hanging on the outer frame.

15. The dishwasher according to claim 14, wherein the basket base includes a frame support on a rear surface, and the body frame has an end portion is detachably coupled to the frame support.

16. The dishwasher according to claim 14, wherein the basket base includes a base fixing part protruded from a rear surface for coupling with the accommodation frame.

17. The dishwasher according to claim 16, wherein the base fixing part has a predetermined radius of curvature.

18. The dishwasher according to claim 14, wherein utensil basket further includes a utensil holder detachably coupled to the body frame, the utensil holder having a hoop shape for supporting the silverware.

19. The dishwasher according to claim 18, wherein the utensil basket further includes one or more utensil holders, and all the utensil holders are vertically arranged at a predetermined distance from each other.
